(19) United States
(12) Patent Application Publication
(10) Pub. No.: US 2009/0110533 A1
(43) Pub. Date: Apr. 30, 2009

(54) MANIPULATOR SYSTEM AND MANIPULATOR CONTROL METHOD

(75) Inventor: Makoto JINNO, Ashigarakami-gun (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 12/262,822

(22) Filed: Oct. 31, 2008

(30) Foreign Application Priority Data
Oct. 31, 2007 (JP) 2007-283953

(51) Int. Cl. B65G 47/22; G06F 19/00

(52) U.S. Cl. 414/783; 700/245; 901/31

(57) ABSTRACT

A manipulator has an operating unit including a trigger lever, a distal end working unit including an end effector and a yaw axis and a roll axis for changing the direction of the end effector, and a connector shaft interconnecting the operating unit and the distal end working unit. The operating unit includes an actuator block housing therein motors for actuating the yaw axis and the roll axis and a gripper operational quantity corrector for mechanically transmitting an operational action of the trigger lever to actuate the end effector. A controller calculates an interference amount caused on the end effector by the attitude angles of the yaw axis and the roll axis. The gripper operational quantity corrector is controlled by the controller to extend or retract a push rod, for correcting the operational quantity of the operational action of the trigger lever to compensate for the interference amount.

### BACKGROUND OF THE INVENTION

1. Field of the Invention

The present invention relates to a manipulator system and a manipulator control method, the manipulator system comprising a manipulator having a distal end working unit which includes an end effector axis and at least one attitude axis for changing the direction of the end effector axis, and a controller for controlling the manipulator. More particularly, the present invention relates to a manipulator system comprising a mechanism for operating the end effector axis and the attitude axis, and a manipulator control method.

2. Description of the Related Art

According to a laparoscopic surgical operation process, some small holes are opened in the abdominal region, for example, of a patient and a flexible scope and manipulators or forceps are inserted into the holes. The surgeon performs a surgical operation on the patient with the manipulators or forceps while watching an image captured by the flexible scope and displayed on a display monitor. Since the laparoscopic surgical operation process does not require a laparotomy, it is less burdensome on the patient and greatly reduces the number of days required for the patient to spend before recovering from the operation or being released from the hospital, it is expected to increase a range of surgical operations to which it is applicable.

Manipulators for laparoscopic surgical operations are required to allow the operator, i.e., the surgeon, to perform various appropriate techniques quickly depending on the position and size of the affected part, for removing, suturing, and ligating the affected part. The applicant has proposed manipulators which can be manipulated simply with a high degree of freedom (see, for example, JP 2002-102248 A and JP 2004-301275 A).

When the surgeon uses forceps of the general nature in a laparoscopic surgery or a flexible scope surgery, external forces applied to the distal end working unit of the forceps and gripping forces applied by the distal end working unit are transmitted, not directly, but as reactive forces, to the hand of the surgeon. Therefore, the surgeon can feel those forces to a certain extent and can operate the forceps based on the reactive forces. The forceps that have been available heretofore, however, have few degrees of freedom, e.g., one degree of freedom, are difficult to handle because they are movable only in limited directions to grip and cut tissues and also to insert suture needles, and require surgeons to be skilled in using them.

To achieve higher degrees of freedom, one option is to use a master-slave remote control surgical robot, for example. The master-slave remote control surgical robot is advantageous in that it has high degrees of freedom, can approach the affected part of a patient from various desired directions, and can be operated effectively and efficiently. However, external forces applied to the distal end working unit and gripping forces applied by the distal end working unit are not transmitted to the master side of the master-slave remote control surgical robot.

If a force feeling is to be available on the master side of the master-slave remote control surgical robot, then the surgical robot will need to be an expensive and complex system as it needs a highly sophisticated bilateral control architecture based on a highly sensitive force sensing system and a computer system having high-speed sampling times. In addition, the bilateral control architecture has not yet reached a practically sufficient performance level at present.

The applicant has already proposed multiple-degree-of-freedom forceps including a distal end working unit having joints that can be actuated by motors based on commands from an operating unit. Since the operating unit, i.e., an operating handle, and the working unit, i.e., distal end joints, are integrally coupled to each other, external forces applied to the distal end working unit and gripping forces applied by the distal end working unit are transmitted, not directly, but via the multiple-degree-of-freedom forceps, to the operating unit. Therefore, the operator of the multiple-degree-of-freedom forceps can feel those forces to a certain extent. Nevertheless, there are demands for multiple-degree-of-freedom forceps which allow the operator to feel stronger forces, in particular, multiple-degree-of-freedom forceps which allow the operator to feel stronger gripping forces.

### SUMMARY OF THE INVENTION

It is one of the objects of the present invention to provide a manipulator system and a manipulator control method, which have high degrees of freedom and which allow the operator to feel reliably and simply external forces applied to a distal end working unit and other forces.

According to one aspect of the present invention, there are provided a manipulator system and a manipulator control method, the manipulator system including a manipulator and a controller for controlling the manipulator, comprising an operating unit including an input unit which is manually operated, a distal end working unit including an end effector axis and at least one attitude axis for changing the direction of the end effector axis, a connector interconnecting the operating unit and the distal end working unit, an attitude-axis actuator for actuating the attitude axis, an operational action transmitter for mechanically transmitting an operational action from the input unit which is manually operated to actuate the end effector axis, and an operational quantity adjuster disposed in the operational action transmitter, for adjusting the operational quantity of the operational action from the input unit which is manually operated.

The operational action transmitter allows the end effector axis to be directly actuated manually by an operator. The operator is capable of reliably and simply sensing external forces applied to the distal end working unit. Since the end effector axis can be changed in its direction by the attitude axis, the manipulator system has high degrees of freedom. The operational quantity adjuster can adjust the effect of the attitude axis.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a side elevational view of a manipulator system and a manipulator according to an embodiment of the present invention;

FIG. 2 is a plan view of the manipulator system and the manipulator;

FIG. 3 is a perspective view of a distal end working unit of the manipulator;

FIG. 4 is an exploded perspective view of the distal end working unit;

FIG. 5 is a side elevational view of a gripper operational quantity corrector at the time a trigger lever is not operated;

FIG. 6 is a side elevational view of the gripper operational quantity corrector at the time the trigger lever is pulled sufficiently;

FIG. 7 is a side elevational view of the gripper operational quantity corrector at the time the trigger lever is pulled to an intermediate position;

FIG. 8 is a block diagram of a controller of the manipulator system;

FIG. 9 is a side elevational view of the gripper operational quantity corrector at the time a roll axis is operated in one direction;

FIG. 10 is a side elevational view of the gripper operational quantity corrector at the time a roll axis is operated in another direction;

FIG. 11 is a side elevational view of a modified gripper operational quantity corrector; and

FIG. 12 is an exploded perspective view of a modified distal end working unit.

### DESCRIPTION OF THE PREFERRED EMBODIMENTS

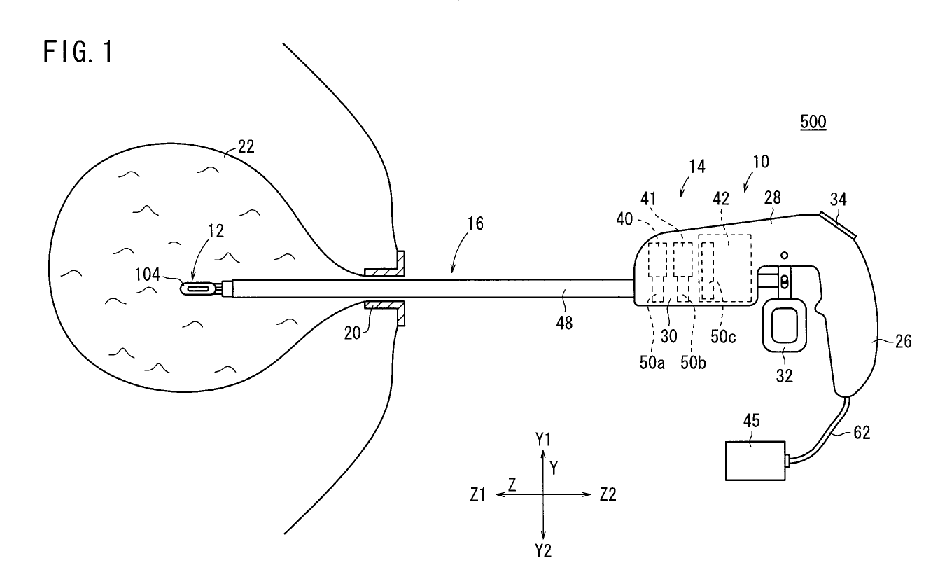

Manipulator systems according to preferred embodiments of the present invention will be described below with reference to FIGS. 1 through 12.

As shown in FIG. 1, a manipulator system 500 according to an embodiment of the present invention comprises a manipulator 10 and a controller 45 for controlling the manipulator 10.

The controller 45, which electrically controls the manipulator 10, is electrically connected to the manipulator 10 by a cable 62 extending from the lower end of a grip handle 26 of the manipulator 10. The controller 45 is capable of controlling a plurality of manipulators 10 independently at the same time as well as the single manipulator 10.

The manipulator 10 including an operating unit 14 and a working unit 16 will be described in detail below.

The manipulator 10 has a distal end working unit 12 for gripping a portion of a living tissue, a curved needle, or the like for performing a certain treatment, and is usually referred to as gripping forceps or a needle driver (needle holder).

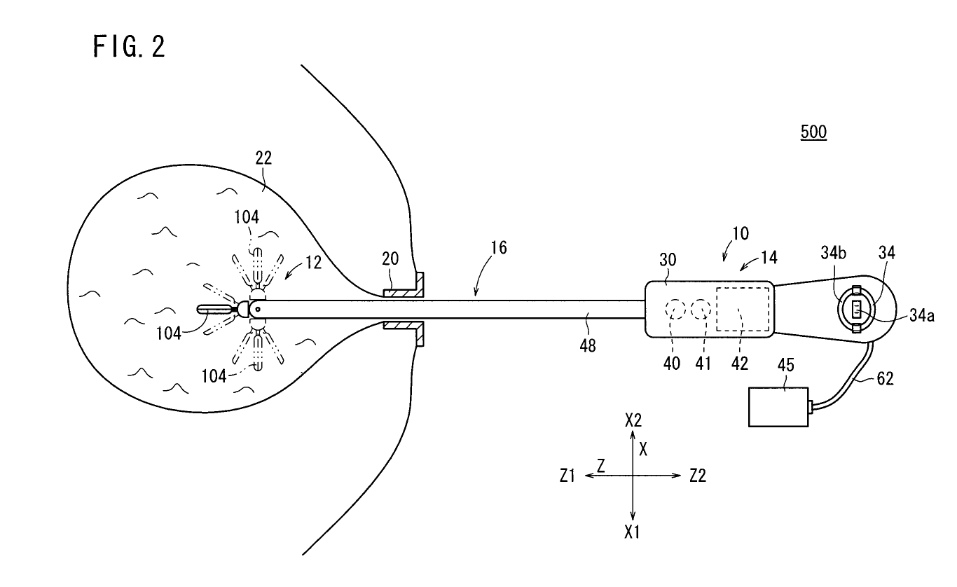

As shown in FIGS. 1 and 2, the manipulator 10 comprises the operating unit 14 on a proximal end portion which is held and operated by hand and the working unit 16 fixedly mounted on the operating unit 14. The operating unit 14 and the working unit 16 are shown as being integrally combined with each other, but may be constructed so as to be separable from each other under certain conditions.

It is assumed in the following description that transverse directions in FIG. 1 are referred to as X directions, vertical directions as Y directions, and longitudinal directions of a connector shaft 48 as Z directions. Of the X directions, the rightward direction as viewed from the distal end is referred to as an X1 direction, and the leftward direction as an X2 direction. Of the Y directions, the upward direction is referred to as a Y1 direction, and the downward direction as a Y2 direction. Of the Z directions, the forward direction is referred to as a Z1 direction, and the rearward direction as a Z2 direction. Unless otherwise noted, these directions represent directions of the manipulator 10 when it is of a neutral attitude. The definition of the above directions is for illustrative purpose only, and the manipulator 10 can be used in any orientations, e.g., it may be used upside down.

The working unit 16 comprises a distal end working unit 12 for performing working operations, and an elongate hollow connector shaft 48 coupling the distal end working unit 12 and the operating unit 14 to each other. The distal end working unit 12 and the connector shaft 48 are of a small diameter and can be inserted into a body cavity 22 through a trocar 20 in the form of a hollow cylinder mounted in an abdominal region or the like of the patient. The distal end working unit 12 is actuated by the operating unit 14 to perform various techniques to grip, remove, suture, or ligate an affected part of the patient's body in the body cavity 22.

The operating unit 14 includes a grip handle 26 gripped by hand, a bridge 28 extending from an upper portion of the grip handle 26, and an actuator block 30 and a trigger lever (input unit) 32 which are connected to a distal end of the bridge 28.

As shown in FIG. 1, the grip handle 26 of the operating unit 14 extends in the Y2 direction from the end of the bridge 28, and has a length suitable for being gripped by hand. The grip handle 26 has a composite input unit 34 disposed thereon.

The cable 62 connected to the controller 45 is disposed on the lower end of the grip handle 26 and is integrally connected to the grip handle 26. The grip handle 26 and the cable 62 may be connected to each other by a connector.

The composite input unit 34 is a composite input means for giving rotational commands in rolling directions (shaft rotating directions) and yawing directions (left and right directions) to the distal end working unit 12. For example, commands in the yawing directions are given by a first input means 34a which operate in lateral directions, and commands in the rolling directions are given by a second input means 34b which operate in the shaft rotating directions. The trigger lever 32 is an input means for giving opening and closing commands for an end effector 104 (see FIG. 1) of the distal end working unit 12. Though the end effector 104 is available in various forms, the manipulator 10 employs an openable and closable gripper.

The composite input unit 34 includes an input sensor for detecting a operational quantity, and supplies a detected operation signal (e.g., an analog signal) to the controller 45.

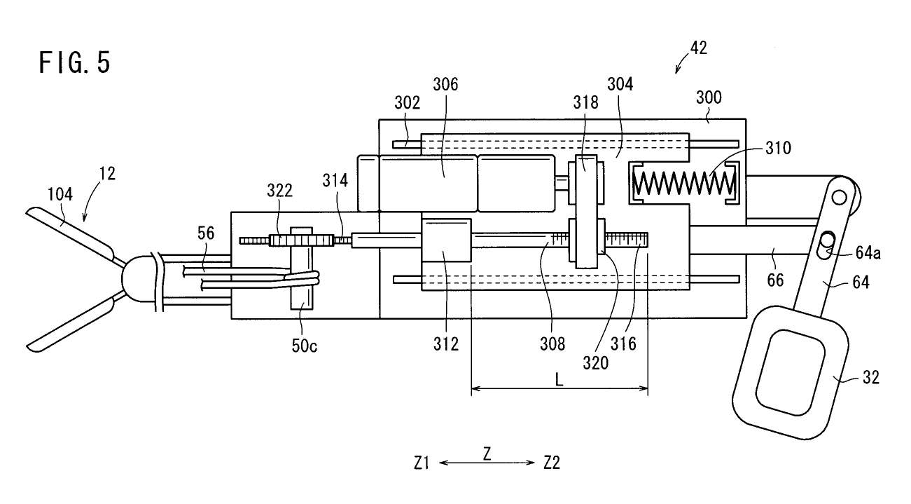

The trigger lever 32 comprises a lever disposed below the bridge 28 in the Y2 direction and is disposed at a position where it can easily be operated by the index finger. The trigger lever 32 is connected to the actuator block 30 by a first link 64 and a second link 66 (see FIG. 5), and is movable toward and away from the grip handle 26. The first link 64 is swingably pivoted on a portion of the bridge 28, and the trigger lever 32 is mounted on the lower end of the first link 64. The second link 66 projects in the Z2 direction from the actuator block 30 and engages in an oblong hole 64a defined in the first link 64. The second link 66 is movable back and forth in the longitudinal direction of the oblong hole 64a when the trigger lever 32 is moved.

The actuator block 30 houses therein motors (attitude-axis actuators) 40, 41 and a gripper operational quantity corrector (gripper operational quantity adjuster) 42 which correspond to respective mechanisms of three degrees of freedom which are incorporated in the distal end working unit 12. The motors 40, 41, and the gripper operational quantity corrector 42 are arrayed parallel to each other in the longitudinal direction of the connector shaft 48. The motors 40, 41 correspond to movements in the rolling and yawing directions of the distal end working unit 12. The gripper operational quantity corrector 42 corresponds to opening and closing movements of the end effector 104. The motors 40, 41 are small in size and diameter, making the actuator block 30 compact and flat in shape. The motors 40, 41 can be energized to rotate their drive shafts under the control of the controller 45 based on the operation of the composite input unit 34.

The motors 40, 41 are combined with angle sensors for detecting rotational angles and supplying detected angle signals to the controller 45. The angle sensors may comprise rotary encoders, for example.

The actuator block 30 houses therein pulleys 50a, 50b connected to the respective drive shafts of the motors 40, 41, and a pulley 50c as part of a gripper actuating mechanism.

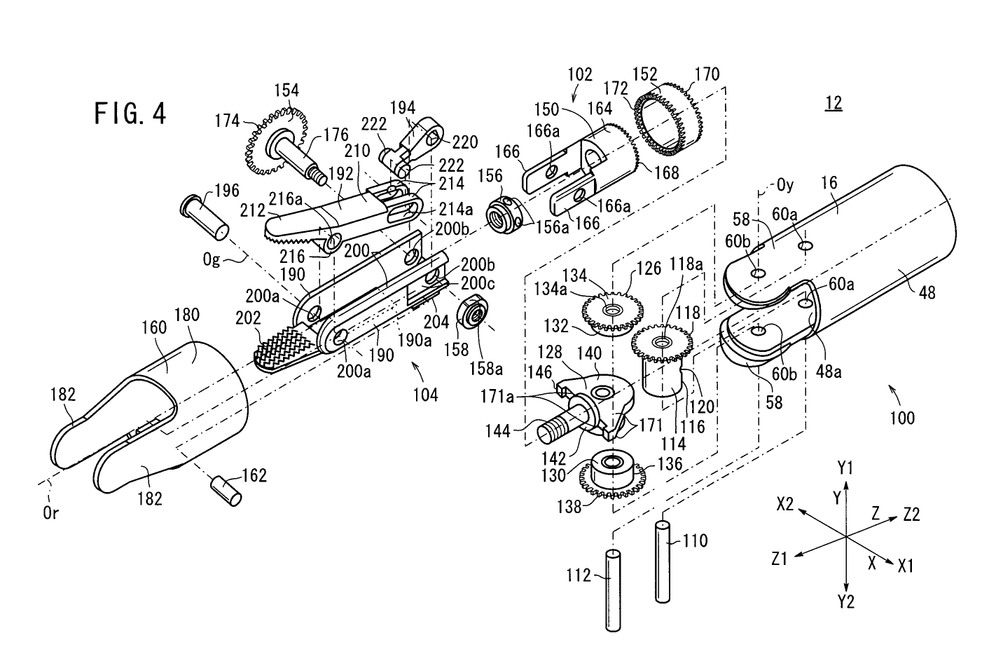

Wires 52, 54, 56 are wound respectively around the pulleys 50a, 50b, 50c, and extend through a hollow region 48a (see FIG. 4) in the connector shaft 48 to the distal end working unit 12. The wires 52, 54, 56 may be of the same type and same diameter.

The composite input unit 34 and the trigger lever 32 of the operating unit 14 are not limited to the positions, the forms, and the operating methods which are illustrated above. For example, the composite input unit 34 may be replaced with operating rollers, buttons, or a joystick, and positions and methods that allow the manipulator to be easily operated may be selected and designed.

A manual operation applied to the trigger lever 32 is mechanically transmitted to open and close the end effector 104. The first link 64, the second link 66, the gripper operational quantity corrector 42, the pulley (rotor) 50c, and the wire (line member) 56 which serve as a means for mechanically transmitting a manual action between the trigger lever 32 and the end effector 104 provide an operation transmitting unit. The term “mechanically” refers to a system for transmitting the manual operation via a wire, a chain, a timing belt, a link, a rod, a gear, or the like, which is mainly actuated by a mechanical component in the form of a solid body that is nonelastic in the power transmitting direction. Though a wire, a chain, or the like is slightly elongatable inevitably under tension, it is regarded as a mechanical component in the form of a nonelastic solid body.

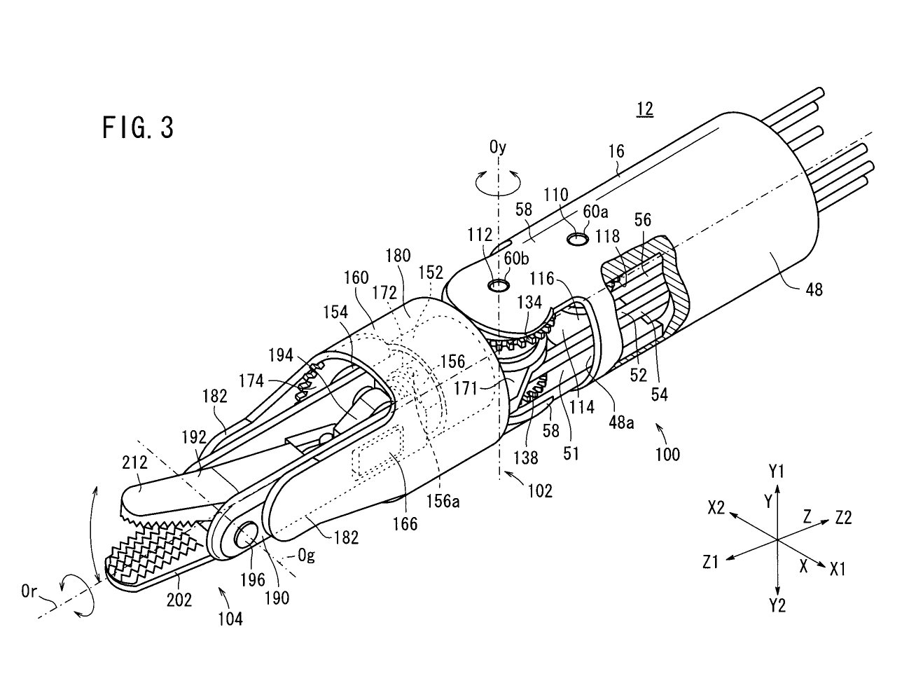

As shown in FIGS. 3 and 4, the distal end working unit 12 comprises a wire-driven mechanism 100, a composite mechanism 102, and an end effector 104. Although the end effector 104 is shown as a double-sided-open-type end effector in FIG. 1, it is shown as being a single-sided-open-type end effector in FIGS. 3 and 4. However, the end effector 104 may be a double-sided-open-type end effector, a single-sided-open-type end effector, or another end effector.

The distal end working unit 12 incorporates therein mechanisms of three degrees of freedom. These mechanisms include a mechanism having a first degree of freedom for angularly moving a portion of the distal end working unit 12 that is positioned ahead of a first rotational axis Oy extending along the Y directions, in yawing directions about the first rotational axis Oy, a mechanism having a second degree of freedom for angularly moving the portion of the distal end working unit 12 in rolling directions about a second rotational axis Or, and a mechanism having a third degree of freedom for opening and closing the end effector 104 on the distal end of the distal end working unit 12 about a third rotational axis Og.

The first rotational axis Oy of the mechanism having the first degree of freedom may be angularly movable out of parallelism with the second rotational axis Or which extends from the proximal end to distal end of the connector shaft 48. The second rotational axis Or of the mechanism having the second degree of freedom may be angularly movable about an axis along the direction in which the distal end (the end effector 104) of the distal end working unit 12 extends, with the distal end portion thereof being rotatable in the rolling directions.

The mechanism having the first degree of freedom (i.e., movable in the yawing directions) has an operable range of ±90° or greater, for example. The mechanism having the second degree of freedom (i.e., movable in the rolling directions) has an operable range of ±180° or greater, for example. The mechanism having the third degree of freedom (i.e., the end effector 104) may be opened through 40° or greater, for example.

The end effector 104 is a member for doing actual works in surgical operations. The first rotational axis Oy and the second rotational axis Or serve to change the attitude of the end effector 104 for facilitating the work. Generally, the mechanism having the third degree of freedom for opening and closing the end effector 104 is referred to as a gripper (or a gripper axis). The mechanism having the first degree of freedom for turning in the yawing directions is referred to as a yaw axis, and the mechanism having the second degree of freedom for turning in the rolling directions is referred to as a roll axis.

The wire-driven mechanism 100 is disposed between a pair of tongues 58 and serves to convert reciprocating movements of respective wires 52, 54, 56 into rotational movements and transmit the rotational movements to a composite mechanism 102. The wire-driven mechanism 100 includes a shaft 110 inserted in shaft holes 60a, 60a, a shaft (perpendicular shaft) 112 inserted shaft holes 60b, 60b, and a gear body 114 rotatably supported on the shaft 110. The shafts 110, 112 are press-fitted or welded securely in the shaft holes 60a, 60b. The shaft 112 is axially aligned with the first rotational axis Oy.

The gear body 114 comprises a tubular member 116 and a gear 118 disposed concentrically on an end of the tubular member 116 in the Y1 direction. The gear 118 is a spur gear which is larger in diameter than the tubular member 116. All gears referred to herein are spur gears unless otherwise specified. The gear 118 has a low annular rib 118a disposed on a surface thereof which faces in the Y1 direction and extending around the hole therein through which the shaft 110 is inserted. The annular rib 118a prevents the surface of the gear 118 which faces in the Y1 direction from contacting the tongue 58 in the Y1 direction, thereby reducing sliding resistance.

The composite mechanism 102 includes an opening/closing mechanism for opening and closing the end effector 104 and an attitude changing mechanism for changing the attitude of the end effector 104.

The composite mechanism 102 comprises a gear body 126 rotatably supported on the shaft 112, a main shaft 128, and a gear body 130, which are successively arranged in the Y2 direction.

The gear body 126 comprises a tubular member 132 and a gear 134 disposed concentrically on an upper portion of the tubular member 132. The gear 134 has the same thickness as the gear 118 and is held in mesh with the gear 118. The gears 118, 134 and a gear 138 referred to below have the same number of gear teeth. If the number of gear teeth of the gear 134 is greater than the number of gear teeth of the gear 118, then the rotation of the gear 118 is transmitted at a reduced speed with an increased torque. The gears may be designed to transmit the rotation of the gear 118 at the same speed or an increased speed. The gear 134 has a low annular rib 134a disposed on an upper surface thereof and extending around the hole therein through which the shaft 112 is inserted. The annular rib 134a prevents the surface of the gear 134 which faces in the Y1 direction from contacting the tongue 58 in the Y1 direction, thereby reducing sliding resistance.

The gear body 130 is essentially identical in shape to the gear body 126, but is in an upside-down orientation with respect to the gear body 126 in the Y directions. The gear body 130 comprises a tubular member 136 and a gear 138 disposed concentrically on a lower portion (in the Y2 direction) of the tubular member 136. The tubular member 136 is substantially identical in diameter and shape to the tubular member 132. The gear 138 has a number of teeth which may be slightly smaller than the gear 134.

The main shaft 128 has a tubular member 140 through which the shaft 112 extends, an annular seat 142 coupled to the tubular member 140 and facing in the Z1 direction, and a support bar 144 extending from the center of the annular seat 142 in the Z1 direction. The support bar 144 is axially aligned with the second rotational axis Or. The support bar 144 has an externally threaded distal end portion.

The annular seat 142 is slightly spaced from an outer side surface of the tubular member 140 with two protective plates 171 interposed therebetween, the protective plates 171 extending in the X directions. Holes 171a are defined between the annular seat 142 and the tubular member 140 for receiving the wire 52 to extend therethrough. The tubular member 140 is combined with a wire securing mechanism 120, which is similar to the wire securing mechanism 120 of the tubular member 116, on the side of the tubular member 140 which faces in the Z2 direction, and the wire 52 is fastened to the tubular member 140 by the wire securing mechanism 120.

The protective plates 171 have 90°-arcuate corners oriented in the Z1 direction and are spread in the Z1 direction. Therefore, the protective plates 171 are generally triangular in shape as viewed in plan.

In response to reciprocating movement of the wire 52, the main shaft 128 rotates in the yawing directions about the first rotational axis Oy to cause the support bar 144 to swing in an XZ plane.

The tubular member 140, the gear body 126, and the gear body 130 are stacked together along the shaft 112 between the tongues 58 with substantially no clearances therebetween.

The tubular members 116, 136, 140 have the respective wire securing mechanisms 120 on their surfaces facing in the Z2 direction, and the wires 56, 52, 54 are secured by the respective wire securing mechanisms 120.

The composite mechanism 102 also has a drive base 150, a gear ring 152, a geared pin 154, fastening nuts 156, 158, and a cover 160. The fastening nut 156 has a plurality of radial small holes 156a defined therein for inserting a narrow rotary tool. At least one of the small holes 156a is exposed radially (see FIG. 4). The fastening nut 158 has parallel surfaces 158a engageable by a rotary tool such as a wrench or the like.

The drive base 150 includes a tubular member 164 rotatably fitted over a proximal portion of the support bar 144, a pair of support arms 166 projecting in the Z1 direction from respective opposite side portions (in the X directions) of the tubular member 164, and a face gear 168 disposed on an end face of the tubular member 164 which faces in the Z2 direction. The support arms 166 serve to support the end effector 104, and have respective holes 166a defined therein which are lined up with each other in the X directions. After the tubular member 164 is fitted over the proximal portion of the support bar 144, the fastening nut 156 is threaded over the externally threaded distal end portion of the support bar 144, whereupon the drive base 150 is rotatably supported on the support bar 144 for rotation in the rolling directions about the axis of the support bar 144, i.e., about the second rotational axis Or.

The face gear 168 is held in mesh with the gear 138. Consequently, the drive base 150 is rotatable about the second rotational axis Or in response to rotation of the tubular member 136.

The gear ring 152 is in the form of a thin tubular member including a face gear 170 on an end face thereof facing in the Z2 direction and a face gear 172 on an end face thereof facing in the Z1 direction. The gear ring 152 is fitted over the tubular member 164 of the drive base 150 for sliding rotation with respect to the outer circumferential surface of the tubular member 164. The gear ring 152 is fitted over the tubular member 164 such that the face gear 170 is slightly displaced off the face gear 168 of the drive base 150 in the Z1 direction and is held in mesh with the gear 134. Since the face gear 170 is in mesh with the gear 134, the gear ring 152 is rotatable about the second rotational axis Or in response to rotation of the gear body 126.

The geared pin 154 includes a gear 174 held in mesh with the face gear 172 and a pin 176 extending in the X1 direction from the center of the gear 174. The pin 176 has an externally threaded distal end portion. The pin 176 extends through the two holes 166a in the support arms 166 and has its externally threaded distal end portion projecting from one of the support arms 166 which is positioned remotely from the gear 174. The fastening nut 158 is threaded over the projecting externally threaded distal end portion of the pin 176. The geared pin 154, with the gear 174 held in mesh with the face gear 172, is rotatably supported by the support arms 166. The pin 176 has a D-shaped cross section for engagement with a portion of the end effector 104.

The cover 160 serves to protect the components of the composite mechanism 102 and the end effector 104, and covers the gear ring 152, the gear 174, etc. The cover 160 includes a tube 180 extending in the Z2 direction and a pair of ears 182 projecting in the Z1 direction from respective opposite side portions of the tube 180 (in the X directions). The ears 182 are of such a shape that circumferential wall portions of the tube 180 extend in the Z1 direction slightly taperingly and smoothly into the respective ears 182. The cover 160 has a lower portion in the Y2 direction fastened to a portion of the end effector 104 by a cover fastening pin 162. The cover 160 has a diameter which is equal to or smaller than the connector shaft 48 as viewed in front elevation.

The cover 160 may be in the form of a hollow cylindrical or conical cover for covering the composite mechanism 102 and the end effector 104 almost in their entirety to the extent that the operation of the composite mechanism 102 and the end effector 104 will not be hampered. The cover 160 may be fastened to the end effector 104 by a pin 196.

The cover 160 serves to prevent foreign matter (living tissues, medications, threads, etc.) from entering the composite mechanism 102 and the end effector 104 as working mechanisms.

The end effector 104 comprises a first end effector member 190, a second end effector member 192, a link 194, and a pin 196. The pin 196 is axially aligned with the third rotational axis Og.

The first end effector member 190 includes a pair of laterally spaced side walls 200 facing each other in the X directions and having respective holes 200a defined in front end portions (facing in the Z1 direction) thereof and respective holes 200b defined in rear end portions (facing in the Z2 direction) thereof, a first gripper 202 projecting in the Z1 direction from lower front end portions of the side walls 200, and a cover mount 204 disposed on lower rear end portions of the side walls 200. The holes 200a are of such a diameter that the pin 196 can be press-fitted therein. The first gripper 202 is slightly tapered along the Z1 direction and has an arcuate distal end portion. The first gripper 202 has a number of closely spaced teeth on an entire surface thereof which faces in the Y1 direction.

The front end portions of the side walls 200 are arcuate in shape. The rear end portions of the side walls 200 have respective recesses 200c defined in outer surfaces thereof for receiving the respective support arms 166 of the composite mechanism 102. The first end effector member 190 has a hole defined between the first gripper 202 and the cover mount 204 for preventing interference with the rear end portion of the second end effector member 192. The cover mount 204 has a hole defined therein for passage of the cover fastening pin 162 therethrough, e.g., to be press-fitted therein.

The second end effector member 192 comprises a base 210, a second gripper 212 projecting in the Z1 direction from a front end of the base 210, a pair of ears 214 extending in the Z2 direction from laterally spaced rear end portions of the base 210, and a shaft support sleeve 216 disposed on a lower surface of the front end of the base 210. The shaft support sleeve 216 has a hole 216a defined therein which has an inside diameter large enough to receive the pin 196 inserted therein. When the pin 196 is inserted into the shaft support sleeve 216 and press-fitted in the hole 200a, for example, the second end effector member 192 is made swingable about the third rotational axis Og. The second gripper 212 is identical in shape to the first gripper 202, but is in an upside-down orientation with respect to the first gripper 202. When the second end effector member 192 is turned counterclockwise in FIG. 4 about the third rotational axis Og, the second gripper 212 is brought into abutment against the first gripper 202, gripping a curved needle or the like therebetween. The ears 214 have oblong holes 214a defined respectively therein.

The link 194 has a hole 220 defined in an end thereof and a pair of engaging fingers 222 disposed on the other end thereof and projecting laterally away from each other (in the X directions). The engaging fingers 222 slidably engage in the respective oblong holes 214a. The hole 220 is of a D-shaped cross section for receiving the pin 176 snugly therein. Therefore, the hole 220 serves to position the pin 176 and prevent the pin 176 from rotating about its own axis. When the pin 176 is inserted in the holes 166a and the holes 200b, 220 and the fastening nut 158 is threaded over the projecting externally threaded distal end portion of the pin 176, the link 194 is made swingable about the pin 176.

The difference between the yaw axis of the distal end working unit 12 and a pitch axis thereof depends on only an initial attitude of the distal end working unit 12 and an attitude of the distal end working unit 12 relative to the operating unit 14. Therefore, the yaw axis may be replaced with the pitch axis. Alternatively, the distal end working unit 12 may have both the yaw axis and the pitch axis.

The axes of the distal end working unit 12 provide interferential mechanisms. The rotational angles of the pulleys 50a through 50c housed in the actuator block 30 and the rotational angles of the attitude axes are not independent of each other. It is assumed that the rotational angle of the attitude control actuator for the yaw axis, i.e., the rotational angle of the pulley 50a, is represented by θ₁, the rotational angle of the attitude control actuator for the roll axis, i.e., the rotational angle of the pulley 50b, is represented by θ₂, the rotational angle of the drive side of the end effector 104, i.e., the rotational angle of the pulley 50c, is represented by θ₃, the rotational angle of the attitude axis for the yaw axis is represented by θ_{y}, the rotational angle of the attitude axis for the roll axis is represented by θr, the opened/closed angle through which the end effector 104 is opened or closed is represented by θ_{g}, and the rotational angle of the gear body 126 which corresponds to the opened/closed angle θ_{g} is represented by θ_{g′}. Torques corresponding to these rotational angles are represented by reference characters similar to those of the rotational angles except that “θ” is replaced with “τ”. It is also assumed that each of the speed reduction ratios of the gears is 1 for the sake of brevity. The relationship between the rotational angles of the actuators or drive units and the rotational angles of the attitude axes, and the relationship between the torques, i.e., mechanism interference matrices, are expressed by the following equations (1), (2):

$$\begin{matrix}[ \begin{matrix}{θ}_{1} \\ {θ}_{2} \\ {θ}_{3}\end{matrix} ] = [ \begin{matrix}1 & 0 & 0 \\ 1 & - 1 & 0 \\ - 1 & - 1 & 1\end{matrix} ] [ \begin{matrix}{θ}_{y} \\ {θ}_{r} \\ {θ}_{{g}^{′}}\end{matrix} ] & ( 1 ) \\ [ \begin{matrix}{τ}_{1} \\ {τ}_{2} \\ {τ}_{3}\end{matrix} ] = [ \begin{matrix}1 & 1 & 2 \\ 0 & - 1 & - 1 \\ 0 & 0 & 1\end{matrix} ] [ \begin{matrix}{τ}_{y} \\ {τ}_{r} \\ {τ}_{{g}^{′}}\end{matrix} ] & ( 2 )\end{matrix}$$

For example, if the attitude axis θ_{y} is to be operated, then the attitude actuator for the yaw axis needs to be operated through not only the angle θ₁, but also θ₂=θ₁, θ₃=−θ₁. If the attitude axis θᵣ is to be operated, then the attitude actuator for the roll axis needs to be operated through not only the angle θ₂, but also θ₃=−θ₁.

The gripper operational quantity corrector 42 will be described below with reference to FIG. 5.

As shown in FIG. 5, the gripper operational quantity corrector 42 comprises a base plate 300, a pair of rails 302, a slide plate 304, a corrective motor (adjusting motor) 306, and a push rod 308.

The base plate 300 is fixed to the actuator block 30. The rails 302 are mounted on the base plate 300 in spaced-apart relationship to each other and extend parallel to the Z directions. The slide plate 304 is guided by the rails 302 for movement in the Z directions. The slide plate 304 is normally urged to move in the Z1 direction by a weak spring 310 acting on the slide plate 304. The second link 66 is coupled to the slide plate 304. When the trigger lever 32 is not operated, the slide plate 304 is displaced in the Z1 direction under the bias of the spring 310. The spring 310 may be dispensed with or may act on the slide plate 304 to normally urge the slide plate 304 to move in the Z2 direction.

The corrective motor 306 is fixedly mounted on the slide plate 304 and has a rotational shaft oriented in the Z directions. The push rod 308 has a central portion extending through and axially movably supported by a spline tube 312 for movement in the Z directions. A rack 314 is connected to the end of the push rod 308 in the Z1 direction. The push rod 308 has an externally threaded end portion 316 extending in the Z2 direction. The push rod 308 has a portion extending from the spline tube 312 to the end of the externally threaded end portion 316 and having a length L when the push rod 308 is positioned in a basic state. The spline tube 312 is fixedly mounted on the slide plate 304. A belt and pulley mechanism 318 is operatively connected between and mounted on the rotational shaft of the corrective motor 306 and the externally threaded end portion 316. The belt and pulley mechanism 318 transmits the rotation of the corrective motor 306 to a nut 320 threaded over the externally threaded end portion 316. The rack 314 is held in mesh with a pinion 322 coaxially mounted on the pulley 50c.

In the manipulator 10 having the gripper operational quantity corrector 42 described above, when the trigger lever 32 is not operated, the slide plate 304 is displaced in the Z1 direction under the bias of the spring 310, keeping the end effector 104 open.

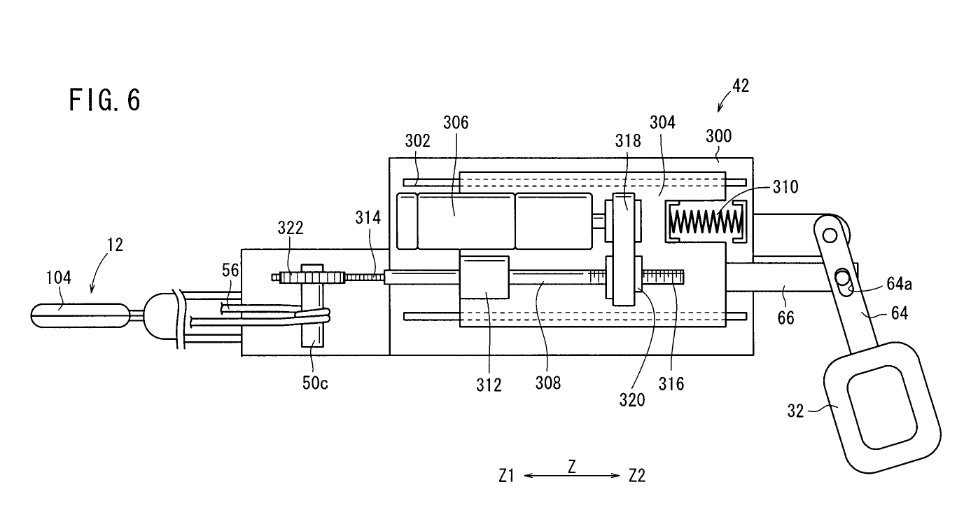

When the trigger lever 32 is manually pulled sufficiently as shown in FIG. 6, the slide plate 304 is pulled in the Z2 direction while compressing the spring 310. The rack 314 rotates the pinion 322 and the pulley 50c, moving the wire 56 to close the end effector 104. At this time, the corrective motor 306 is servo-locked to allow the operational quantity and control force from the manually pulled trigger lever 32 to be transmitted mechanically to the end effector axis. The gripper operational quantity corrector 42 may have a mechanical lock mechanism for transmitting the operational quantity and control force from the manually pulled trigger lever 32.

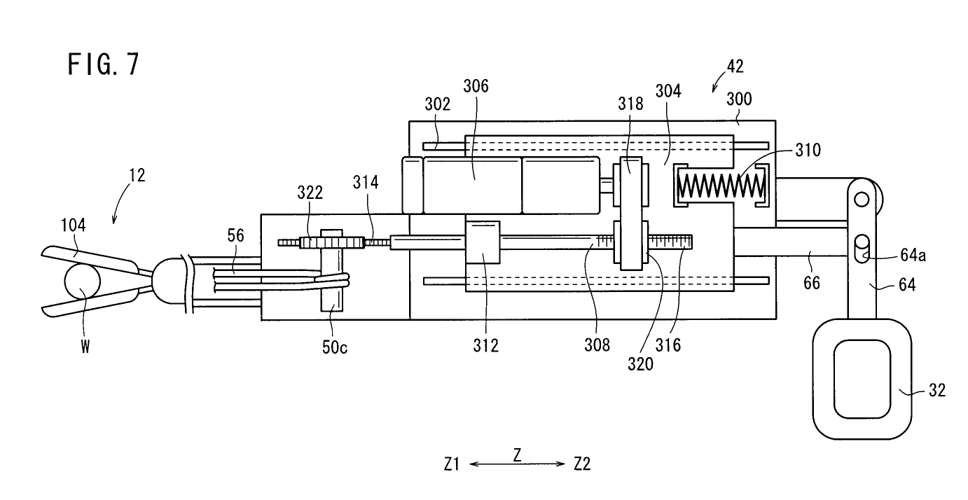

When the trigger lever 32 is manually pulled to an intermediate position as shown in FIG. 7, if the end effector 104 grips an object W such as a surgical instrument, or a living tissue, or the like, then the end effector 104, the gear body 114, and the wire 56 are no longer movable appreciably. In other words, the end effector 104, the gear body 114, and the wire 56 are only movable a distance which is allowed by an elastic deformation of the wire 56 and an elastic deformation of the object W. The slide plate 304, the second link 66, and the trigger lever 32 are also no longer movable in the Z2 direction. The surgeon or operator can now sense, through its finger engaging the trigger lever 32, that the end effector 104 has gripped the object W.

If the object W is a hard object such as a surgical instrument, then the trigger lever 32 is essentially not movable in the Z2 direction. Therefore, the operator can sense that the end effector 104 has gripped something hard, and can reliably grip the object W with strong forces. This is because the manipulator 10 can transmit manual forces mechanically and directly to the end effector 104 without the need for electromagnetic forces. If the trigger lever 32 is replaced with a motor and gripping forces equivalent to manual forces are to be generated by the motor and transmitted to the end effector 104 through the lock mechanism in the gripper operational quantity corrector 42, then the motor needs to be considerably large and heavy, cannot neatly be housed in the actuator block 30, and hence adds to the weight of the manipulator 10. If the slide plate 304 is fixed by a certain lock mechanism and the corrective motor 306 is to generate gripping forces, then the corrective motor 306 will also suffer the same disadvantages.

If the object W is a soft object such as a living tissue, then the trigger lever 32 is somewhat displaceable in the Z2 direction as the object W is elastically deformable. The operator can sense that the end effector 104 has gripped something soft, recognize how soft the object W is, and can adjust its own gripping forces for gripping the object W.

The manipulator 10 transmits not only closing forces of the end effector 104 but also opening forces of the end effector 104 to the trigger lever 32. In other words, when the end effector 104 is brought into contact with a living tissue, a surgical instrument, or the like while the end effector 104 is being opened, the trigger lever 32 becomes immovable in the Z1 direction. Therefore, the operator senses that the end effector 104 has contacted something as it is being opened.

When the wires and gears of the manipulator 10 are worn or deteriorated, the manipulator 10 also transmits forces due to increased wear to the trigger lever 32, allowing the operator to sense a change in the state of the wires and gears or an abnormal condition of the actuating system made up of those wires and gears and other components. The operator can thus determine when to service the manipulator 10 for maintenance.

The manipulator 10 is also an energy saver because the end effector 104 is basically manually operable by the operator using the trigger lever 32.

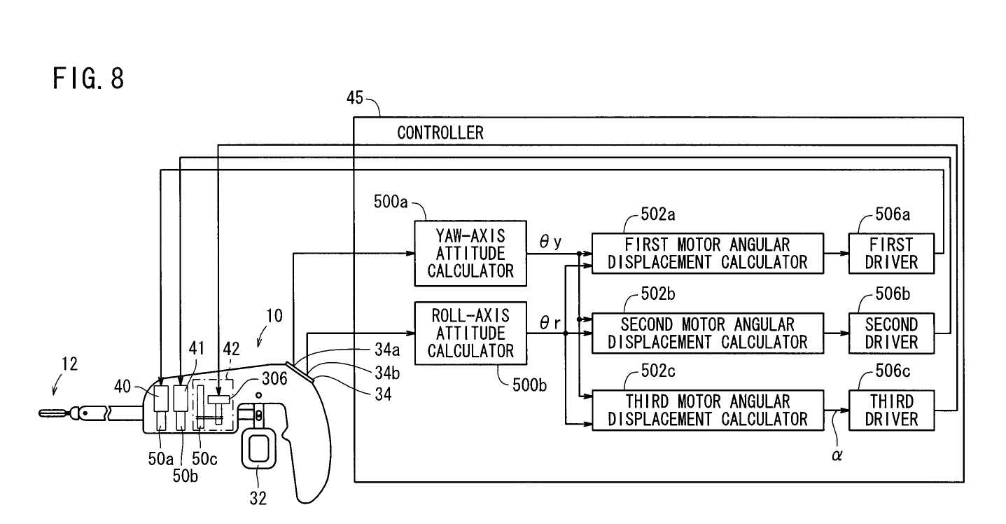

As shown in FIG. 8, the controller 45 includes a yaw-axis attitude calculator 500a and a roll-axis attitude calculator 500b. The yaw-axis attitude calculator 500a calculates a yaw-axis angle θ_{y} based on an operational action of the first input means 34a, and the roll-axis attitude calculator 500b calculates a roll-axis angle θᵣ based on an operational action of the second input means 34b. Specifically, the yaw-axis attitude calculator 500a and the roll-axis attitude calculator 500b calculate the yaw-axis angle θ_{y} and the roll-axis angle θᵣ by integrating the operational actions in a positive or negative direction of the first input means 34a and the second input means 34b.

The controller 45 also includes a first motor angular displacement calculator 502a, a second motor angular displacement calculator 502b, a third motor angular displacement calculator (calculating unit) 502c, a first driver 506a, a second driver 506b, and a third driver 506c.

If the yaw axis and the roll axis are actuated by a differential mechanism, then the first motor angular displacement calculator 502a calculates an angular displacement θ₁ of the motor 40 based on the yaw-axis angle θ_{y} and the roll-axis angle θᵣ.

The first motor angular displacement calculator 502a calculates an angular displacement θ₁ of the motor 40 based on the yaw-axis angle θ_{y}. The second motor angular displacement calculator 502b calculates an angular displacement θ₂ of the motor 41 based on the yaw-axis angle θ_{y} and the roll-axis angle θᵣ. The third motor angular displacement calculator 502c calculates an interference amount α with respect to the end effector 104 based on the yaw-axis angle θ_{y} and the roll-axis angle θᵣ. The third driver 506c energizes the corrective motor 306 in order to compensate for the interference amount α.

As indicated by the above equation (1), since the distal end working unit 12 has a mechanism interference, when the attitude axes are to be actuated, it is necessary to correctively actuate the end effector 104 depending on the mechanism interference for the purpose of preventing the trigger lever 32 from being changed in position and also preventing the end effector 104 from being actuated regardless of the intention of the operator.

The third motor angular displacement calculator 502c enables the corrective motor 306 to rotate the pulley 50c as a rotor through an appropriate angular displacement amount in order to correct the mechanism interference amount α in timed relation to the actuation of the yaw axis and the roll axis. The end effector 104 can thus be kept in a desired attitude even if the trigger lever 32 is held constant when the yaw axis and the roll axis are actuated. This virtually provides non-interferential mechanisms. Since a corrective quantity (adjusting quantity) can be determined from the angles of the yaw axis and the roll axis, it can simply be determined according to the equation (1) with respect to the mechanism interference matrices.

For example, a corrective quantity at the time the angle of the yaw axis is θ_{y} can be determined by putting θ_{y}=θ_{y}, θᵣ=0 (the angle of the roll axis is 0), and θ_{g′}=0 (the angle of the gripper is 0) into the equation (1) with respect to the mechanism interference matrices. Therefore, the corrective motor 306 may be energized so that θ₃=−θ_{y}.

A corrective quantity at the time the angle of the roll axis is θᵣ can be determined by putting θ_{y}=0 (the angle of the yaw axis is 0), or θᵣ=θr, and θ_{g′}=0 (the angle of the gripper is 0) into the equation (1). Therefore, the corrective motor 306 may be energized so that θ₃=−θᵣ.

Similarly, when the angle of the yaw axis is θ_{y} and the angle of the roll axis is θᵣ, the corrective motor 306 may be energized so that θ₃=−θ_{y}−θᵣ.

The corrective quantity represents a relative quantity for correcting a reference value. For illustrative purposes, the corrective quantity is herein indicated as an absolute angular corrective (adjusting) value. If the corrective motor 306 has a sufficient torque for the gripping torque and the actuating torque of the gripper operational quantity corrector 42, then the manipulator 10 can change the yaw axis and the roll axis even when the operator is generating gripping forces.

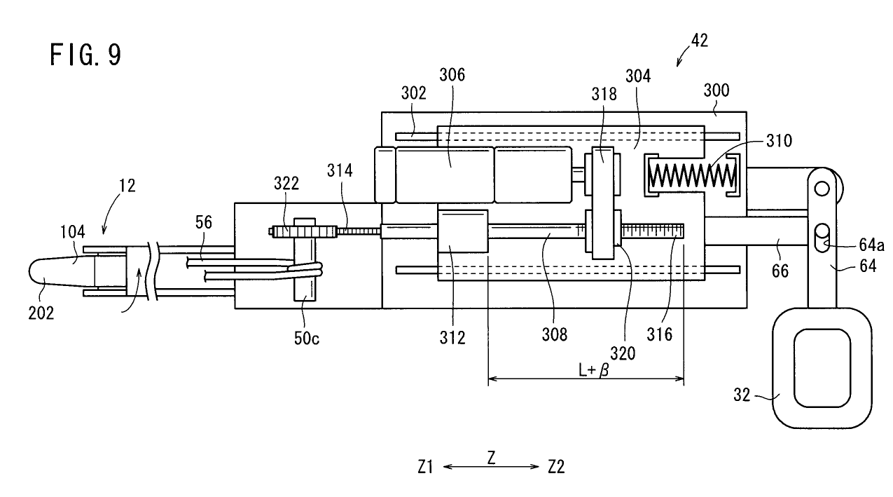

As shown in FIG. 9, when the roll axis is rotated in one direction through +90°, for example, the controller 45 calculates an interference amount a so that the opening of the end effector 104 will not change, and energizes the corrective motor 306 to displace the push rod 308 in a direction to increase the length L to L+β from the spline tube 312, for example.

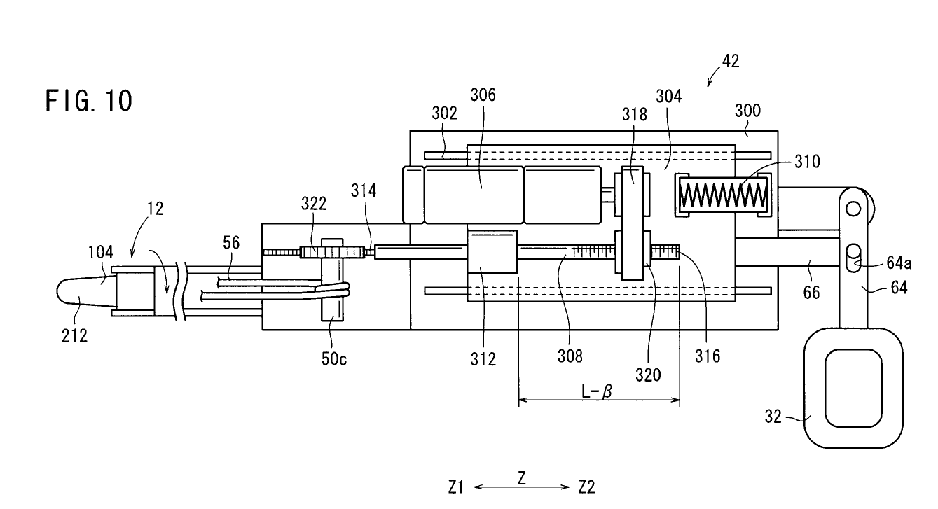

As shown in FIG. 10, when the roll axis is rotated in the other direction through −90°, for example, the controller 45 calculates an interference amount a so that the opening of the end effector 104 will not change, and energizes the corrective motor 306 to displace the push rod 308 in a direction to reduce the length L to L−β from the spline tube 312, for example. At this time, the opening of the end effector 104 and the position of the trigger lever 32 remain unchanged in position. This holds true also when the yaw axis is changed and when the yaw axis and the roll axis are changed in combination. The attitude axes may be changed while the end effector 104 is being opened or closed. In this case, a corrective quantity may be determined according to the mechanism interference matrices depending on the angles of the attitude axes.

With the manipulator system 500 and the manipulator control method according to the present embodiment, as described above, when the end effector 104 is opened and closed, the control forces of the trigger lever 32 are transmitted from the trigger lever 32 through the gripper operational quantity corrector 42 to the rack 314, which applies the corresponding torque through the pinion 322 to the pulley 50c which actuates the gripper axis, thereby moving the wire 56. When the corrective motor 306 is servo-locked, the push rod 308 is not extended or retracted thereby, so that the control forces of the trigger lever 32 can mechanically be transmitted to the end effector 104. The opening or closing forces or torque of the trigger lever 32 is thus mechanically transmitted directly to the end effector 104, and the opening or closing torque of the end effector 104 is transmitted to the trigger lever 32. The operator can sense reactive forces from the object W as representing whether the object W is hard or soft. The operator can then easily adjust the gripping forces, and change living tissues and suture needles to be gripped.

When the attitude axes are actuated, the corrective motor 306 is energized to rotate the externally threaded end portion 316 of the push rod 308 to extend or retract the push rod 308 for thereby correcting the end effector 104 depending on the actuation of the yaw axis and the roll axis. A corrective quantity, e.g., an interference amount α, is determined according to the mechanism interference matrices. When only the attitude axes are actuated, the trigger lever 32 is not changed in position, but the push rod 308 can be extended or retracted to correct the end effector 104 out of the mechanism interference.

A gripping torque generated by the end effector 104, e.g., a torque for strongly gripping the object W in FIG. 7, imparts a torque interference to an attitude axis (in this case, the roll axis according to the equation (2)). If the actuating system (the wires 52, 54) for the attitude axes is sufficiently rigid, and the attitude-axis actuators (the motors 40, 41) generate sufficient torques, then no problem will arise. If the actuating system is not sufficiently rigid, then the angles of the attitude axes tend to vary. For example, when the end effector 104 generates a strong torque, the roll axis or the like is displaced.

In this case, target angular positions for the motors 40, 41 may be corrected depending on the torque generated by the end effector 104 (τ_{g′} according to the equation (2)). The torque generated by the end effector 104 can be estimated from the current value of the corrective motor 306. Alternatively, the torque generated by the end effector 104 may be measured by a torque sensor added to the manipulator 10.

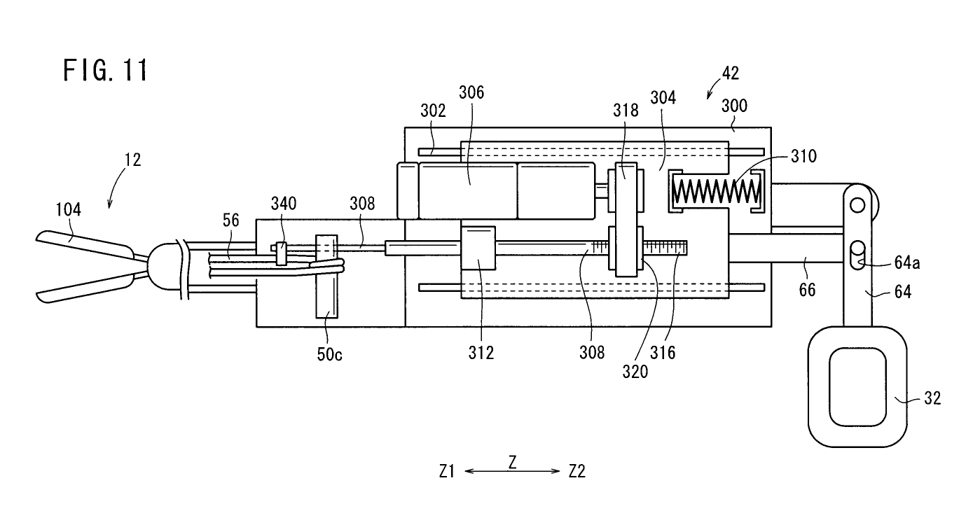

In the present embodiment, the gripper operational quantity corrector 42 actuates the pulley 50c and the wire 56 through the rack 314 and the pinion 322. However, as shown in FIG. 11, the push rod 308 may have its distal end fixed to the wire 56 by a terminal 340, so that the push rod 308 will directly move the wire 56. Furthermore, a link, a gear, or the like may be added to increase or reduce the control forces applied to the end effector 104 by the operator or the stroke of the end effector 104 moved by the operator.

In the present embodiment, the angular movement of the trigger lever 32 (the first link 64) is converted into a linear movement of the second link 66, and the push rod 308 is extended or retracted to correct the linear movement of the second link 66. Based on the corrected linear movement of the second link 66, the rack and pinion mechanism rotates the pulley 50c to operate the end effector 104. Alternatively, a rotary mechanism for correcting a rotational angle may be employed by rotational movement between the angular movement of the trigger lever 32 and the angular movement of the pulley 50c, to operate the end effector 104.

The end effector 104 is not limited to the gripper, but may be in the form of scissors or rotary electrodes having openable and closable members.

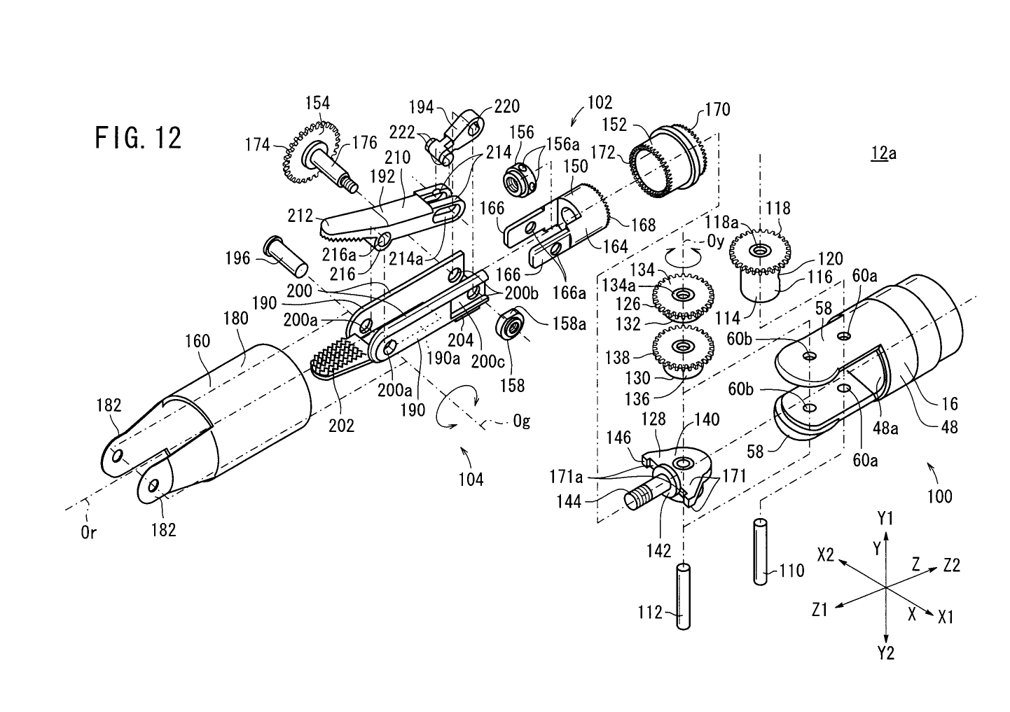

A modified distal end working unit 12a will be described below with reference to FIG. 12 (see FIGS. 3 and 4). Those parts of the modified distal end working unit 12a which are identical to those of the distal end working unit 12 are denoted by identical reference characters, and will not be described in detail below.

As shown in FIG. 12, the distal end working unit 12a includes a gear body 126, a gear body 130, and a main shaft 128, which are successively arranged in the Y2 direction for a shaft 112. The gear body 130 is oriented in the same direction as the gear body 126. The distal end working unit 12a also includes a stepped gear ring 152 having a face gear 170 on an end face thereof facing in the Z2 direction and a face gear 172 on an end face thereof facing in the Z1 direction, the face gears 170, 172 being of the same diameter.

The face gear 170 is held in mesh with the gear 134, so that the gear ring 152 is rotatable about the second rotational axis Or in response to rotation of the gear body 126, and the face gear 168 is held in mesh with the gear 138, so that the drive base 150 is rotatable about the second rotational axis Or in response to rotation of the tubular member 136, as with the corresponding mechanisms of the distal end working unit 12. The heights of the gear body 126, the gear body 130, and the main shaft 128 are selected such that the gears are held in mesh with each other as described above.

The distal end working unit 12a is basically the same as the distal end working unit 12 (see FIG. 3) except for the gears described above. Therefore, a perspective representation of the distal end working unit 12a is omitted from illustration.

As with the distal end working unit 12, the distal end working unit 12a is applicable to the manipulator 10 and can be controlled by the controller 45.

The axes of the distal end working unit 12a provide interferential mechanisms. The rotational angles of the pulleys 50a through 50c housed in the actuator block 30 and the rotational angles of the attitude axes are not independent of each other. In the distal end working unit 12a, it is assumed that each of the speed reduction ratios of the gears is 1 for the sake of brevity. The relationship between the rotational angles of the actuators or drive units and the rotational angles of the attitude axes, and the relationship between the torques, i.e., mechanism interference matrices, are expressed by the following equations (3), (4):

$$\begin{matrix}[ \begin{matrix}{θ}_{1} \\ {θ}_{2} \\ {θ}_{3}\end{matrix} ] = [ \begin{matrix}1 & 0 & 0 \\ 1 & 1 & 0 \\ - 1 & - 1 & 1\end{matrix} ] [ \begin{matrix}{θ}_{y} \\ {θ}_{r} \\ {θ}_{{g}^{′}}\end{matrix} ] & ( 3 ) \\ [ \begin{matrix}{τ}_{1} \\ {τ}_{2} \\ {τ}_{3}\end{matrix} ] = [ \begin{matrix}1 & - 1 & 0 \\ 0 & 1 & 1 \\ 0 & 0 & 1\end{matrix} ] [ \begin{matrix}{τ}_{y} \\ {τ}_{r} \\ {τ}_{{g}^{′}}\end{matrix} ] & ( 4 )\end{matrix}$$

When the distal end working unit 12a is applied to the manipulator 10, the controller 45 may correctively actuate the end effector 104 depending on the mechanism interference based on the above equations (3), (4).

The manipulator 10 and the distal end working units 12, 12a have been illustrated as being used in the medical application. However, they can also be used in industrial applications other than the medical application. For example, with a manipulator system and a manipulator control method according to the present embodiments, the manipulator 10 and the distal end working units 12, 12a are applicable to robots, manipulators, and distal end working units for performing repairing and maintenance operations in need of grip feelings and strong gripping forces in narrow regions within energy-related devices, energy-related facilities and regions that cannot directly be accessed by human operators.

Although certain preferred embodiments of a manipulator system and a manipulator control method according to the present invention have been shown and described in detail, it should be understood that various changes and modifications may be made therein without departing from the scope of the appended claims.

What is claimed is:

1. A manipulator system including a manipulator and a controller for controlling the manipulator, comprising:
an operating unit including an input unit which is manually operated;
a distal end working unit including an end effector axis and at least one attitude axis for changing the direction of the end effector axis;
a connector interconnecting the operating unit and the distal end working unit;
an attitude-axis actuator for actuating the attitude axis;
an operational action transmitter for mechanically transmitting an operational action from the input unit which is manually operated to actuate the end effector axis; and
an operational quantity adjuster disposed in the operational action transmitter, for adjusting the operational quantity of the operational action from the input unit which is manually operated.

2. A manipulator system according to claim 1, wherein the end effector axis provides an interferential mechanism whose actuated quantity is variable depending on an angle of the attitude axis;
the controller has a calculating unit for calculating an interference amount caused on the end effector axis by the angle of the attitude axis; and
the operational quantity adjuster is controlled by the controller to adjust the operational quantity to compensate for the interference amount.

3. A manipulator system according to claim 1, wherein the operational action transmitter includes a rotor, and the operational quantity adjuster rotates the rotor to adjust the operational quantity.

4. A manipulator system according to claim 1, wherein the operational action transmitter includes a line member, and the operational quantity adjuster moves the line member to adjust the operational quantity.

5. A manipulator control method comprising the steps of:
transmitting an operational action from an input unit which is manually operated to a given operational quantity adjuster;
adjusting an operational quantity of the operational action from the input unit by the operational quantity adjuster; and
actuating an end effector axis on a distal end by transmitting the adjusted operational quantity to the end effector axis,
wherein the manipulator comprises:
an operating unit including the input unit;
a distal end working unit including the end effector axis and at least one attitude axis for changing a direction of the end effector axis;
a connector interconnecting the operating unit and the distal end working unit; and
an attitude-axis actuator for actuating the attitude axis.

6. A manipulator control method according to claim 5, wherein the end effector axis provides an interferential mechanism whose actuated quantity is variable depending on an angle of the attitude axis;
a calculating unit is provided for calculating an interference amount caused on the end effector axis by the angle of the attitude axis; and
the operational quantity adjuster adjusts the operational quantity to compensate for the interference amount.

7. A manipulator control method according to claim 5, wherein the operational action transmitter includes a rotor, and the operational quantity adjuster rotates the rotor to adjust the operational quantity.

8. A manipulator control method according to claim 5, wherein the operational action transmitter includes a line member, and the operational quantity adjuster moves the line member to adjust the operational quantity.
